(19) United States
(12) Patent Application Publication
(10) Pub. No.: US 2008/0049269 A1
(43) Pub. Date: Feb. 28, 2008

(54) Image-acquiring device

(75) Inventor: Yen-Cheng Chen, Hsinchu (TW)

Correspondence Address: BIRCH STEWART KOLASCH & BIRCH, PO BOX 747, FALLS CHURCH, VA, 22040-0747, US

(73) Assignee: Avision Inc.

(21) Appl. No.: 11/812,941

(22) Filed: Jun. 22, 2007

(30) Foreign Application Priority Data
Aug. 28, 2006 (TW) 95131588

(51) Int. Cl. H04N 1/04

(52) U.S. Cl. 358/474

(57) ABSTRACT

The present invention provides an image-acquiring device for scanning a to-be-scanned document which includes first page data and second page data. The device includes a first scan module, a second scan module, a first transmission interface and a second transmission interface. The first scan module scans the first page data and outputs a corresponding first digital signal. The second scan module scans the second page data and outputs a corresponding second digital signal. The first transmission interface receives the first digital signal from the first scan module and outputs the first digital signal to a computer host. The second transmission interface receives the second digital signal from the second scan module and outputs the second digital signal to the computer host.

This application claims the benefit of Taiwan application Serial No. 95131588, filed Aug. 28, 2006, the subject matter of which is incorporated herein by reference.

### BACKGROUND OF THE INVENTION

1. Field of the Invention

The invention relates in general to an image-acquiring device, and more particularly to an image-acquiring device having a duplex scan function and a high transmission speed.

2. Description of the Related Art

With the rapid development of the scanners, the requirement on the quality of the scanned image is getting higher and higher. Recently, the scanners have become much more popularized due to the growth of the scan technology and the rise of the high speed transmission interface. The main function of the scanners is to scan an image of a printed document and convert the scanned image into an electric file, which may be conveniently broadcasted, used or reserved. In addition to the increased resolution and the enhanced scan quality, the development of the scanners is also directed toward the increased scanning speed with the lead-in and the development of the automatic document feeding technology and the duplex image acquiring technology.

FIG. 1 (Prior Art) is a system block diagram showing a conventional scanner 10 with a duplex scan function. Referring to FIG. 1, the scanner 10 includes two scan modules respectively on top and bottom sides of a transparent platen to perform a one pass duplex scanning operation on a document placed on the transparent platen. In the scanner 10, a first scan module, which is disposed under the transparent platen and disposed in a housing 100, is for scanning first page data of the document and includes a first image sensor 102, a first A/D converter 104 and a first memory 106. A second scan module, which is disposed above the transparent platen and disposed in an automatic document feeder (ADF) 110, is for scanning second page data of the document and includes a second image sensor 112, a second A/D converter 114 and a second memory 116.

When the scanner 10 is acquiring an image, the ADF 110 transports the to-be-scanned document through a passage between the first image sensor 102 of the housing 100 and the second image sensor 112 of the ADF 110 so that the first image sensor 102 and the second image sensor 112 can simultaneously read the data on both sides of the to-be-scanned document. The first image sensor 102 and the second image sensor 112 respectively read the first page data and the second page data and generate analog signals, which are respectively converted, by the first A/D converter 104 and the second A/D converter 114, into digital signals that can be processed in a digital manner.

Next, an application specific integrated circuit (ASIC) 108 first processes the digital signal of the first page data and transfers the processed digital signal of the first page data to a computer host 12 through a transmission interface 118. During this processing procedure, the digital signal of the second page data converted by the second A/D converter 114 is temporarily stored in the second memory 116. After the first page data has been completely processed, the digital signal of the second page data temporarily stored in the second memory 116 is processed. Then, the processed digital signal of the second page data is transferred to the computer host 12 through the transmission interface 118.

However, the image resolution for the image processing is getting higher and higher and the advanced scanner is gradually developed. For example, the resolution is increased from 600 or 1200 dpi to 9600 dpi. Each of the digital signal of the first page data and the digital signal of the second page data occupies a larger capacity than the prior art due to the increased resolution. When the document is scanned with the high resolution, the digital signal of the first page data and the digital signal of the second page data are processed by the ASIC and then transferred to the computer host through the transmission interface at a limited speed caused by the specifications of various transmission interfaces. Thus, the file transmission capacity cannot be effectively enhanced, and the bottleneck for the high resolution and the quick scan still cannot be solved. Thus, the overall efficiency is decreased.

### SUMMARY OF THE INVENTION

The invention is directed to an image-acquiring device having a duplex scan function and using two transmission interfaces to speed up the digital signal transmission.

According to the present invention, an image-acquiring device is provided. The image-acquiring device is for scanning a to-be-scanned document including first page data and second page data. The image-acquiring device includes a first scan module, a second scan module, a first transmission interface and a second transmission interface. The first scan module scans the first page data and outputs a corresponding first digital signal. The second scan module scans the second page data and outputs a corresponding second digital signal. The first transmission interface receives the first digital signal from the first scan module and outputs the first digital signal to a computer host. The second transmission interface receives the second digital signal from the second scan module and outputs the second digital signal to the computer host.

The invention will become apparent from the following detailed description of the preferred but non-limiting embodiments. The following description is made with reference to the accompanying drawings.

### BRIEF DESCRIPTION OF THE DRAWINGS

FIG. 1 (Prior Art) is a system block diagram showing a conventional scanner with a duplex scan function.

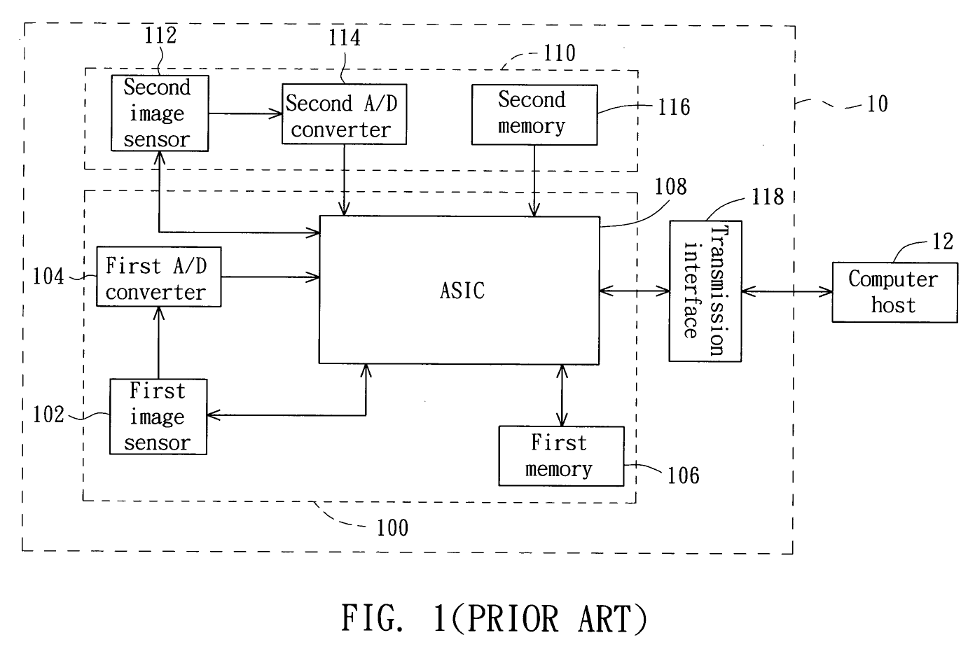

FIG. 2 is a system block diagram showing an image-acquiring device according to a preferred embodiment of the invention.

### DETAILED DESCRIPTION OF THE INVENTION

The invention provides an image-acquiring device having a duplex scan function and two transmission interfaces (i.e., double head double port, DHDP) to speed up the digital signal transmission.

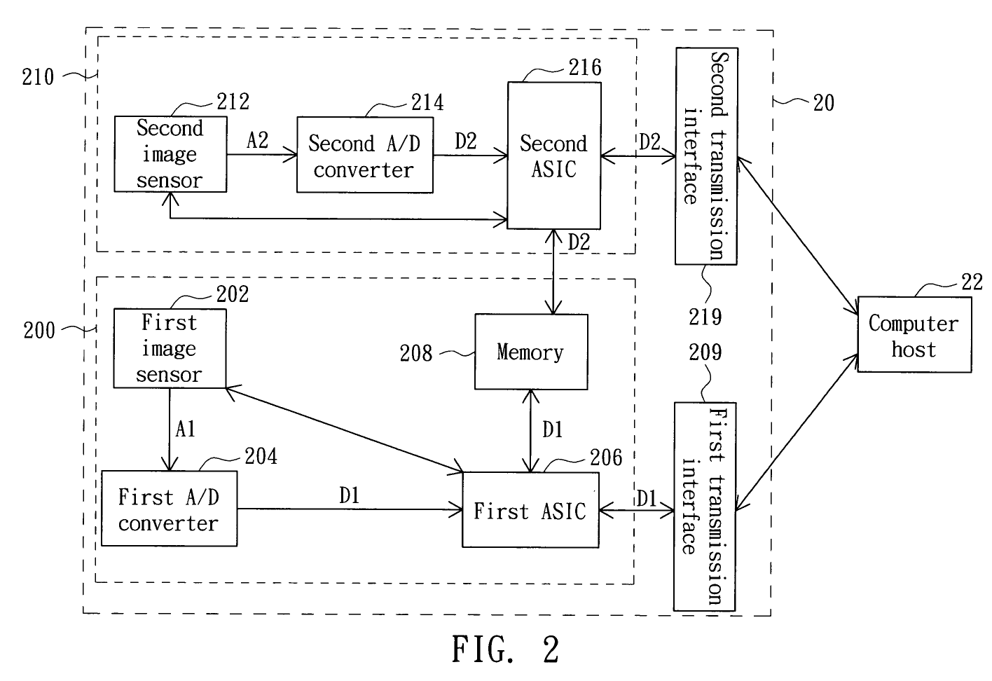

FIG. 2 is a system block diagram showing an image-acquiring device according to a preferred embodiment of the invention. Referring to FIG. 2, the image-acquiring device 20 could be a scanner or a multi-function peripheral for scanning a to-be-scanned document with first page data and second page data. The image-acquiring device 20 includes a first scan module 200, a first transmission interface 209, a second scan module 210 and a second transmission interface 219. The first scan module 200 is disposed in a housing of the image acquiring device. The second scan module is disposed in an automatic document feeder (ADF). The image acquiring device can be a flatbed scanner in combination with an ADF, where the housing forms the flatbed and the ADF is mounted on the flatbed. However, the invention is not particularly limited thereto as long as the first page data and the second page data of the to-be-scanned document can be scanned. Thus, the first scan module 200 and the second scan module 210 may also be disposed at different positions, dependent upon the design of the image acquiring device. For example, if the image acquiring device is a sheet-fed scanner, the first scan module 200 and the second scan module 210 may be disposed on two opposite sides of a sheet-feeding path of the sheet-fed scanner.

When the image-acquiring device 20 is acquiring an image, the to-be-scanned document is transported across the first scan module 200 in the housing and the second scan module 210 in the ADF. The first scan module 200 scans the first page data of the to-be-scanned document and outputs a corresponding first digital signal D1. The first transmission interface 209 receives the first digital signal D1 from the first scan module 200 and outputs the first digital signal D1 to a computer host 22. The second scan module 210 scans the second page data of the to-be-scanned document and outputs a corresponding second digital signal D2. The second transmission interface 219 receives the second digital signal D2 from the second scan module 210 and outputs the second digital signal D2 to the computer host 22. In addition, the image-acquiring device 20 may also output the first digital signal D1 and the second digital signal D2 to another device, such as a printer for performing a printing operation to directly print data of the to-be-scanned document on a sheet.

In the image-acquiring device 20, the first scan module 200 includes a first image sensor 202, a first A/D converter 204, a first application specific integrated circuit (ASIC) 206 and a memory 208. The first image sensor 202 may be, for example, a charge coupled device (CCD) sensor or a contact image sensor (CIS) for acquiring one of unit quantities of the first page data, where the first image sensor 202 is exposed to one of unit quantities of the first page data and generates a corresponding first analog signal A1. The first A/D converter 204 converts the first analog signal A1 into the first digital signal D1.

The first ASIC 206 controls the exposure timing of the first image sensor 202 and outputs the first digital signal D1 to the first transmission interface 209. The memory 208 temporarily stores the first digital signal D1.

The second scan module 210 includes a second image sensor 212, a second A/D converter 214 and a second ASIC 216. The second image sensor 212, such as a CCD sensor or a CIS, is exposed to one of unit quantities of the second page data and generates a corresponding second analog signal A2. The second A/D converter 214 converts the second analog signal A2 into the second digital signal D2. The second ASIC 216 controls the exposure timing of the second image sensor 212 and outputs the second digital signal D2 to the second transmission interface 219. The memory 208 temporarily stores the second digital signal D2.

In this invention, the image-acquiring device 20 can output data convergently or divergently, and the first ASIC 206 and the second ASIC 216 control the exposure timing of the first image sensor 202 and the exposure timing of the second image sensor 212.

When the data is outputted convergently, the first image sensor 202 continuously acquires the first page data by the unit quantity until the first page data has been completely acquired, and the second image sensor 212 also continuously acquires the second page data by the unit quantity until the second page data has been completely acquired. When the first page data and the second page data are completely acquired, they are outputted to the corresponding first transmission interface 209 and the corresponding second transmission interface 219 through the first ASIC 206 and the second ASIC 216, respectively, and then transferred to the computer host 22. Alternatively, the first image sensor 202 and the second image sensor 212 could intermittently acquire the first page data and the second page data, respectively, by the unit quantity in order to generate an image of lower resolution.

When the first page data and the second page data are being acquired, the digital signals received by the first ASIC 206 and the second ASIC 216 are temporarily stored in the memory 208 serving as a data buffer. If the transmission speeds of the first transmission interface 209 and the second transmission interface 219 are greater than or equal to the speed of the first image sensor 202 and the second image sensor 212 converting the data into the analog signals and transmitting the analog signal to the A/D converter, no memory is needed to serve as the data buffer for temporarily storing the data.

In addition, when the data is outputted divergently, the analog signals generated by the first image sensor 202 and the second image sensor 212 are outputted per unit quantity, and the unit quantity outputted may be a scan line or a pixel. The first image sensor 202 and the second image sensor 212 respectively transmit the unit quantity of the first analog signal and the second analog signal to the first A/D converter 204 and the second A/D converter 214, respectively. The first A/D converter 204 converts the received unit quantity of the first analog signal into the unit quantity of the first digital signal, and the second A/D converter 214 converts the received unit quantity of the second analog signal into the unit quantity of the second digital signal.

The first ASIC 206 and the second ASIC 216 respectively control the exposure timing of the first image sensor 202 and the exposure timing of the second image sensor 212, and output the unit quantity of the first digital signal D1 and the unit quantity of the second digital signal D2. Finally, the first digital signal D1 and the second digital signal D2 are transferred to the computer host 22 through the first transmission interface 209 and the second transmission interface 219, respectively. The first transmission interface 209 and the second transmission interface 219 could be universal serial bus (USB) interfaces, and may also be other high speed transmission interfaces.

In addition, the computer host 22 has at least two connection ports for respectively receiving the first digital signal D1 and the second digital signal D2. After receiving the first digital signal D1 and the second digital signal D2, the computer host 22 runs image processing software to integrate the first digital signal D1 with the second digital signal D2 to obtain an electric file of the to-be-scanned document.

The image-acquiring device according to the embodiment of the invention has the duplex scan function and two transmission interfaces (DHDP). As the user's requirement on the image resolution is getting higher and higher (e.g., the resolution of 600 or 1200 dpi is increased to the resolution of 9600 dpi), the file sizes of the first digital signal sensed by the first image sensor and the second digital signal sensed by the second image sensor are larger than those of the conventional signals due to the increased resolution. So, the signals are transferred to the computer host through the two transmission interfaces and then integrated by the image processing software. Consequently, the transmission speed can be greatly increased and the effects of high resolution and high speed scan can be obtained.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An image-acquiring device for scanning a to-be-scanned document having first page data and second page data, the image-acquiring device comprising:
a first scan module for scanning the first page data and outputting a corresponding first digital signal;
a second scan module for scanning the second page data and outputting a corresponding second digital signal;
a first transmission interface for receiving the first digital signal from the first scan module and outputting the first digital signal to a computer host; and
a second transmission interface for receiving the second digital signal from the second scan module and outputting the second digital signal to the computer host.

2. The device according to claim 1, wherein the first scan module comprises:
a first image sensor for acquiring one of unit quantities of the first page data and generating a corresponding first analog signal;
a first N/D converter for converting the first analog signal into the first digital signal;
a memory for temporarily storing the first digital signal and the second digital signal; and
a first application specific integrated circuit (ASIC) for controlling exposure timing of the first image sensor and outputting the first digital signal to the first transmission interface.

3. The device according to claim 2, wherein the first image sensor continuously acquires the first page data by the unit quantity until the first page data has been completely acquired.

4. The device according to claim 2, wherein the first image sensor intermittently acquires the first page data by the unit quantity.

5. The device according to claim 2, wherein the unit quantity is a scan line or a pixel.

6. The device according to claim 2, wherein the first image sensor is a charge coupled device (CCD) sensor or a contact image sensor (CIS).

7. The device according to claim 1, wherein the second scan module comprises:
a second image sensor for acquiring one of unit quantities of the second page data and generating a corresponding second analog signal;
a second A/D converter for converting the second analog signal into the second digital signal; and
a second application specific integrated circuit (ASIC) for controlling exposure timing of the second image sensor and outputting the second digital signal to the second transmission interface.

8. The device according to claim 7, wherein the second image sensor continuously acquires the second page data by the unit quantity until the second page data has been completely acquired.

9. The device according to claim 7, wherein the second image sensor intermittently acquires the second page data by the unit quantity.

10. The device according to claim 7, wherein the unit quantity is a scan line or a pixel.

11. The device according to claim 7, wherein the second image sensor is a charge coupled device (CCD) sensor or a contact image sensor (CIS).

12. The device according to claim 1, wherein both of the first transmission interface and the second transmission interface are universal serial bus (USB) interfaces.

13. The device according to claim 1 further comprising a housing, wherein the first scan module is disposed in the housing.

14. The device according to claim 1 further comprising an automatic document feeder, wherein the second scan module is disposed in the automatic document feeder.

15. The device according to claim 1, wherein the first transmission interface outputs the first digital signal to a printer, and the second transmission interface outputs the second digital signal to the printer.

16. The device according to claim 1 being a scanner.

17. The device according to claim 1 being a multi-function peripheral.
